(19) United States
(12) Patent Application Publication
(10) Pub. No.: US 2007/0062220 A1
(43) Pub. Date: Mar. 22, 2007

(54) Vapor axial deposition apparatus and vapor axial deposition method

(75) Inventors: Sung-Wook Bang, Gumi-si (KR); Yeong-Seop Lee, Gumi-si (KR); Dong-Hi Lee, Chilgok-gun (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/487,846

(22) Filed: Jul. 17, 2006

(30) Foreign Application Priority Data
Sep. 16, 2005 (KR) 2005-86898

(51) Int. Cl. C03B 37/07; G01N 23/00; C03B 37/018; G01N 21/43

(52) U.S. Cl. 65/377; 65/414; 65/485; 65/378; 65/531

(57) ABSTRACT

Disclosed is a vapor axial deposition apparatus. The vapor axial deposition apparatus includes a first torch, a growth size detecting unit and a controlling unit. The first torch deposits soot on a distal end of a soot preform aligned with a first axis, and is aligned with a second axis. The growth size detecting unit detects an image including a growing point of the soot preform and an end of the first torch. The controlling unit calculates a distance between the soot preform and the first torch along the second axis from the detected image, and moves the soot preform upward based on the calculated distance.

### CLAIM OF PRIORITY

This application claims the benefit of the earlier filing date, pursuant to 35 USC 119, to that patent application entitled “Vapor Axial Deposition Apparatus and Vapor Axial Deposition Method” filed in the Korean Industrial Property Office on Sep. 16, 2005, and assigned Serial No. 2005-86898, the contents of which are hereby incorporated by reference.

### BACKGROUND OF THE INVENTION

1. Field of the Invention

The present invention relates to an apparatus and a method for manufacturing optical fiber preforms, and more particularly to a vapor axial deposition (VAD) apparatus and a vapor axial deposition method.

2. Description of the Related Art

A vapor axial deposition method is a method for obtaining a soot preform by depositing soot on a glass rod by means of first and second torches to grow a core and a clad in a longitudinal direction. Subsequently, the soot preform is subjected to a dehydration process, etc. to obtain an optical fiber preform.

FIG. 1 illustrates a conventional vapor axial deposition apparatus. A vertical-type vapor axial deposition apparatus 100 shown in FIG. 1 includes first and second torches 120, 125 for creating and depositing soot, a torch moving part 130 for moving the first torch 120, a preform moving part 140 for moving and rotating a soot preform 110, a growth size detecting part 150 for measuring the growth size of a core 114 of the soot preform 110, and a controlling part 160 for controlling the preform moving part 140 so as to regulate the constant growth size of the core 114.

The soot preform 110 includes a glass rod 112 for providing a growth base, and the core 114 and a clad 116 formed by depositing soot on a first end of the glass rod 112. The core 114 has a relatively high refractive index, and the clad 116 surrounding the core 114 has a relatively low refractive index. A second end of the glass rod 112, which is positioned opposite to the first end, is fixed to the preform moving part 140, and the soot preform 110 is rotated at a predetermined speed during the soot deposition.

The first torch 120 emits a flame toward a distal end of the soot preform 110 to grow the core 114 from the first end of the glass rod 112 in a longitudinal direction. The first torch 120 is provided with glass raw material and fuel material. As the glass raw material is dehydrated within the emitted flame, soot is produced, and the produced soot is deposited on the soot preform 110.

The torch moving part 130 initially aligns the first torch 120 and the soot preform 110 prior to the soot deposition by moving the first torch 120 in a transverse direction.

The second torch 125 emits a flame toward an outer circumferential surface of the core 114 to grow the clad 116 on the outer circumferential surface of the core 114. The second torch 125 is provided with glass raw material and fuel material. As the glass raw material is dehydrated within the emitted flame, soot is produced, and the produced soot is deposited on the soot preform 110.

The preform moving part 140 fixes the second end of the glass rod 112 thereto, and rotates the soot preform 110 at a predetermined speed. The preform moving part 140 also moves the soot preform 110 upward under the control of the controlling part 160.

The growth size detecting part 150 includes a He—Ne laser 152 and a photodiode 154. Light outputted from the He—Ne laser 152 transmits a growing point of the core 114 (corresponding to an end of the core 114), and is inputted into the photo the photodiode 154. The photodiode 154 outputs the input transmitted light into an electrical signal.

The controlling part 160 recognizes the power of the transmitted light from the power of the electrical signal inputted from the photodiode 154, and the power of the transmitted light decreases as the growth diameter of the core 114 increases. The controlling part 160 determines the growth diameter of the core 114 from the power of the transmitted light, and moves the soot preform 110 upward so as to make the growth diameter of the core 114 constant. That is, the controlling part 160 moves the soot preform 110 upward if the power of the transmitted light is lower than a predetermined value, thereby maintaining the constant growth size of the core 114.

However, the vapor axial deposition apparatus 100 as described above has the following problems:

Firstly, when the soot deposition is performed for a long time, the He—Ne laser 152 and the photodiode 154 are heated by heats generated in the first and second torches 120, 125, and so the output of the He-Ne laser 152 and the sensitivity of the photodiode 154 may change. This results in measurement errors. Many soot particles, which are generated during the soot deposition process and exist on an optical path, also give rise to measurement errors.

Secondly, although a distance between the soot preform 110 and the first torch 120 may have influence on the shape and the refractive index profile of the soot preform 110 during the soot deposition, there is no means for finding them out. Also, it is impossible to cope with changes in the distance between the soot preform 110 and the first torch 120, which may occur due to changes in process conditions, such as vibration and heat, during the soot deposition.

Because of such problems, the soot preform 110 produced by the vapor axial deposition apparatus 100 undergoes serious change in the shape and the refractive index profile, which deteriorates productivity and reliability.

### SUMMARY OF THE INVENTION

Accordingly, the present invention has been made to solve at least the above-mentioned problems occurring in the prior art, and an object of the present invention is to provide a vapor axial deposition apparatus and a vapor axial deposition method, which can maintain a constant distance between a soot preform and a first torch.

A further object of the present invention is to provide a precise and reliable vapor axial deposition apparatus and a precise and reliable vapor axial deposition method, which can exclude influences of high temperature and soot particles.

In order to accomplish these objects, in accordance with one aspect of the present invention, there is provided a vapor axial deposition apparatus comprising a first torch for depositing soot on a distal end of a soot preform aligned with a first axis, the first torch being aligned with a second axis, a growth size detecting unit for detecting an image from a growing point of the soot preform and an end of the first torch; and a controlling unit for calculating a distance between the soot preform and the first torch along the second axis from the detected image, and moving the soot preform based on the calculated distance.

In accordance with another aspect of the present invention, there is provided a vapor axial deposition method, in which soot is deposited on a distal end of a soot preform aligned with a first axis by using a torch aligned with a second axis, the method comprising the steps of (a) detecting an image including a growing point of the soot preform and a front edge of the torch, (b) calculating a vertical distance between an end point of the soot preform and the front edge of the torch from the detected image, and (c) moving the soot preform such that the distance between the end point of the soot preform and the front edge of the torch is maintained constant.

Preferably, step (b) comprises the steps of: (b-1) extending a segment on a side edge of the torch up to a central axis of the soot preform, (b-2) calculating an included angle formed by the extension line of the segment and the central axis of the soot preform, and (b-3) calculating the vertical distance between the end point of the soot preform and the front edge of the torch from the included angle.

### BRIEF DESCRIPTION OF THE DRAWINGS

The above features and advantages of the present invention will be more apparent from the following detailed description taken in conjunction with the accompanying drawings, in which:

FIG. 1 is a view illustrating a conventional vapor axial deposition apparatus;

FIG. 2 is a view illustrating a vapor axial deposition apparatus in accordance with a preferred embodiment of the present invention; and

FIGS. 3 to 5 are views for explaining a controlling procedure of a controlling unit shown in FIG. 2.

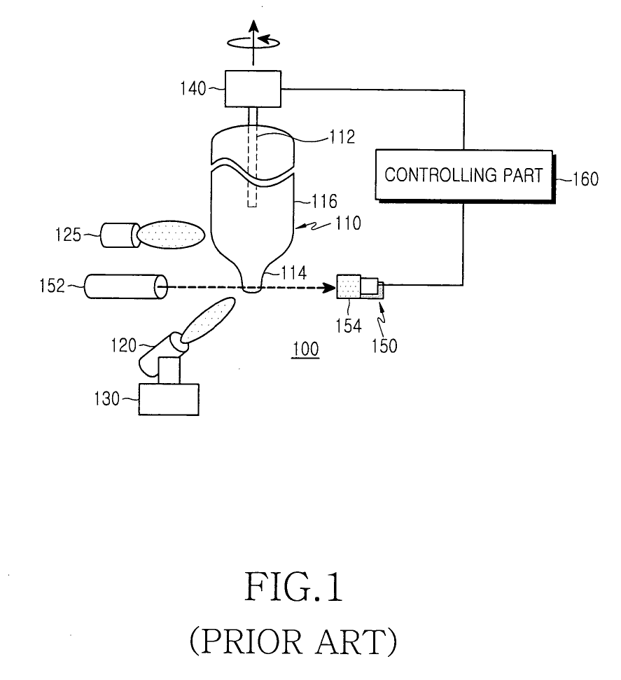

### DETAILED DESCRIPTION OF THE INVENTION

Hereinafter, preferred embodiments of the present invention will be described with reference to the accompanying drawings. It should be noted that the similar components are designated by similar reference numerals although they are illustrated in different drawings. For the purposes of clarity and simplicity, a detailed description of known functions and configurations incorporated herein will be omitted as it may obscure the subject matter of the present invention.

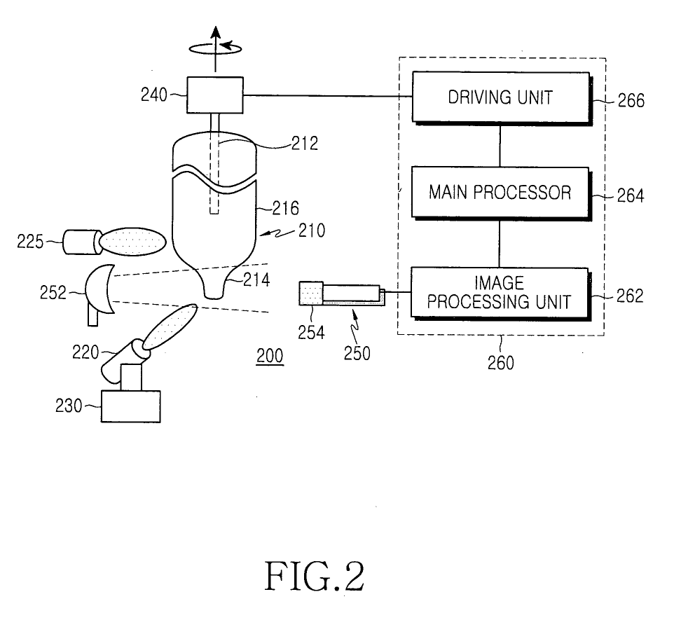

FIG. 2 illustrates a vapor axial deposition apparatus according to a preferred embodiment of the present invention. The vapor axial deposition apparatus 200 includes first and second torches 220, 225 for creating and depositing soot, a torch moving unit 230 for moving the first torch 220, a preform moving unit 240 for moving and rotating a soot preform 210, a growth size detecting unit 250 for measuring the core grown size of the soot preform 210, and a controlling unit 260 for controlling the preform moving unit 240 so as to regulate the core growth size of the soot preform 210. At this time, the soot preform 210, the first and second torches 220, 225, the torch moving unit 230 and the preform moving unit 240 are packaged within a chamber (not shown), and the growth size detecting unit 250 and the controlling unit 260 are disposed outside the chamber. The chamber has first and second windows positioned opposite to each other, and the growth size detecting unit 250 can measure the core grown size of the soot preform 210 through the first and second windows.

The soot preform 210 is aligned with a first axis (corresponding to a central axis thereof), and includes a glass rod 212 for providing a growth base, and a core 214 and a clad 216 formed by depositing soot on a first end of the glass rod 212. The core 214 has a relatively high refractive index, and the clad 216 surrounding the core 214 has a relatively low refractive index. A second end of the glass rod 212, which is positioned opposite to the first end, is fixed to the preform moving unit 240, and the soot preform 210 is rotated at a predetermined speed during the soot deposition.

The first torch 220 is aligned with a second axis (corresponding to a central axis thereof) (not shown) inclined at a predetermined acute angle to the first axis, and emits a flame toward a distal end of the soot preform 210 to grow the core 114 from the first end of the glass rod 212 in a first axial direction. The first torch 220 is provided with glass raw material and fuel material. As the glass raw material is dehydrated within the emitted flame, soot is produced, and the produced soot is deposited on the soot preform 210.

The torch moving unit 230 moves the first torch 220 in a direction perpendicular to the first axis to thereby initially align the first torch 220 and the soot preform 210 prior to the soot deposition.

The second torch 225 emits a flame toward an outer circumferential surface of the core 214 to grow the clad 216 on the outer circumferential surface of the core 214. The second torch 225 is provided with glass raw material and fuel material. As the glass raw material is dehydrated within the emitted flame, soot is produced, and the produced soot is deposited on the soot preform 210.

The preform moving unit 240 fixes the second end of the glass rod 212 thereto, and rotates the soot preform 210 at a predetermined speed. The preform moving unit 240 also moves the soot preform 210 upward under the control of the controlling unit 260.

The grown size detecting unit 250 includes an illuminating device 252 and an image detecting device 254.

The illuminating device 252 is disposed on one side of the soot preform 210, and illuminates together at least a growing point of the core 214 and an end of the first torch 220. A halogen lamp outputting white light or the like may be used as the illuminating device 252.

The image detecting device 254 is disposed on the other side of the soot preform 210 such that it is positioned opposite to the illuminating device 252, and detects an image including the growing point of the core 214 and the end of the first torch 220 to output the detected image. A CCD (Charge-Coupled Device) camera may be used as the image detecting device 254.

The controlling unit 260 calculates a distance between an end point of the soot preform 210 and a front edge of the first torch 220 along the second axis, and moves the soot preform 210 upward based on the calculated distance. The controlling unit 260 includes an image processing device 262, a main processor 264 and a driving device 266. The controlling unit 260 may be implemented as a personal computer (PC). To be specific, the image processing device 262 may be implemented as a grabber card mounted within the PC, the main processor 264 may be implemented as a microprocessor of the PC, and the driving device 266 may be implemented as an interface card mounted within the PC.

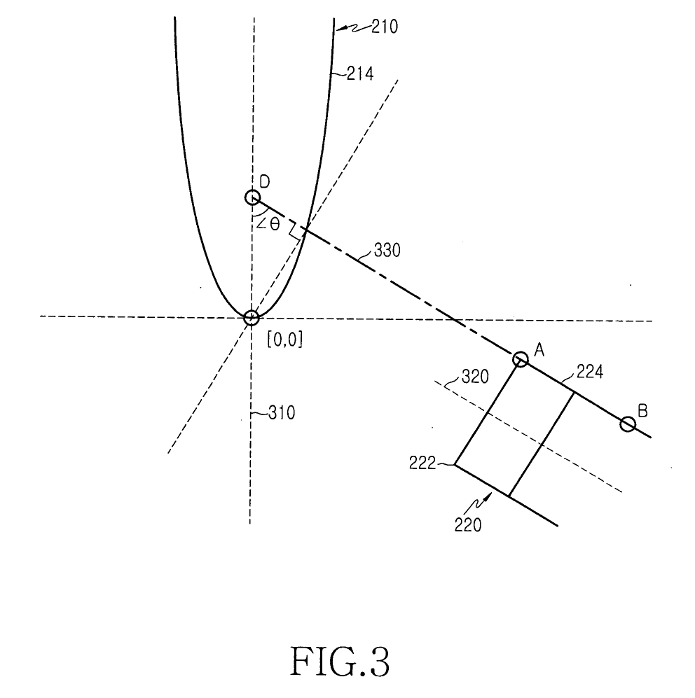

FIGS. 3 to 5 are views for explaining a controlling procedure of the controlling unit 260.

Referring to FIG. 3, the image processing device 262 capture the end point of the soot preform 210, and sets the captured end point as an origin [0, 0]. At this time, the x-axis on the coordinate plane becomes the first axis 310, and the y-axis becomes an axis perpendicular to the first axis 310 and passing through the origin. The origin is located on the first axis 310, and soot preform 210 has rotational symmetry about the first axis 310. Also, the image processing device 262 forms an included angle θ formed by the first axis 310 and an extension line 330 obtained by extending a segment connecting arbitrary two points A and B on a side edge 224 of the first torch 220. The first torch 220 has a hollow cylindrical shape, and has rotational symmetry about its central axis, that is, the second axis 320. The second axis 320 is parallel to the extension line 330.

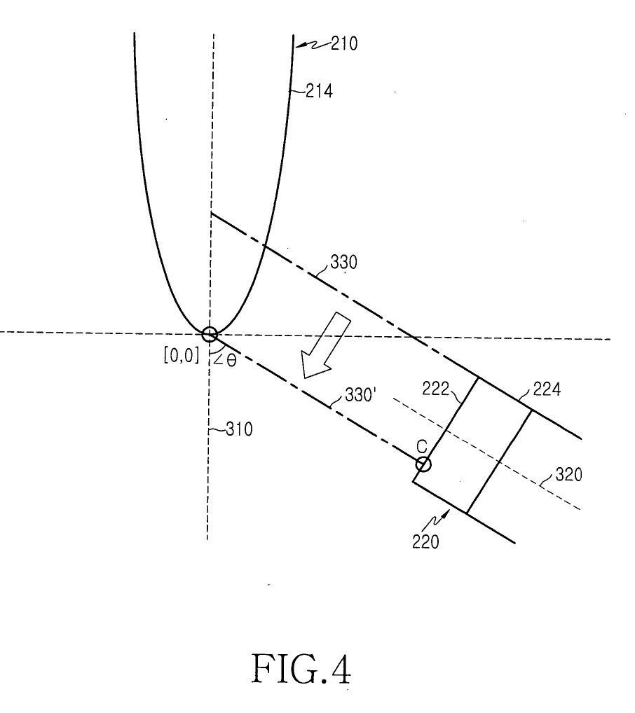

Referring to FIG. 4, the image processing device 262 moves the extension line 330 in a parallel direction along the first axis 330, and finds an intersecting point C at which the moved extension line 330 meets the front edge 222 of the first torch 220. Otherwise, the image processing device 262 may find an intersecting point C at which a straight line passing through the origin and having the included angle θ with the first axis 330 meets the front edge 222 of the first torch 220. Subsequently, the image processing device 262 calculates the distance between the origin and the intersecting point C.

Optionally, the two points A and B on the side edge 224 of the first torch 220 may be selected such that the point A corresponds to a corner of the first torch 220. In this case, the image processing device 262 finds an intersecting point D [0, P] at which an extension line 330 obtained by extending a segment connecting the two points A and B meets the first axis 310, and an included angle θ formed by the extension line 330 and the first axis 310. Subsequently, the image processing device 262 calculates a distance between the point A and the intersecting point D, and calculates a value obtained by subtracting P·cos θ from the calculated distance.

The image processing device 262 inputs numerical data, which is obtained by calculating the vertical distance between the end point of the soot preform 210 and the front edge 222 of the first torch 220, into the main processor 264.

In another aspect, it is possible to form a recognizable segment on an outer circumferential surface of the first torch 220, and then calculate a vertical distance between the end point of the soot preform 210 and the segment. At this time, the segment is formed perpendicularly to the second axis 320. Otherwise, it is also possible to form a recognizable cross mark, which consists of a segment a first segment perpendicular to the second axis 320 and a second segment perpendicular to the first segment, on the outer circumferential surface of the first torch 220.

The main processor 264 compares the numerical data inputted from the image processing device 262 with a predetermined reference value, and outputs a control signal to the driving device 266 so as to compensate for a difference between the numerical data and the predetermined reference value. The main processor 264 moves the soot preform 210 upward if the numerical data is less than the predetermined value, thereby maintaining the constant distance between the end point of the soot preform 210 and the front edge 222 of the first torch 220.

In this embodiment, maintaining the constant distance between the end point of the soot preform 210 and the front edge 222 of the first torch 220 results in the constant growth size. Thus, the vapor axial deposition apparatus 100 realizes a servo system which automatically moves the soot preform 210 upward according to its growth size.

If necessary, the main processor 264 may cumulatively store a series of numerical data inputted from the image processing device 262 to determine growing speed from the cumulatively stored numerical data. That is, the main processor 264 may divide a length difference between two numerical data inputted at unit time intervals by the unit time to thereby determine a length difference per unit time, from which the main processor 264 can derive the growing speed.

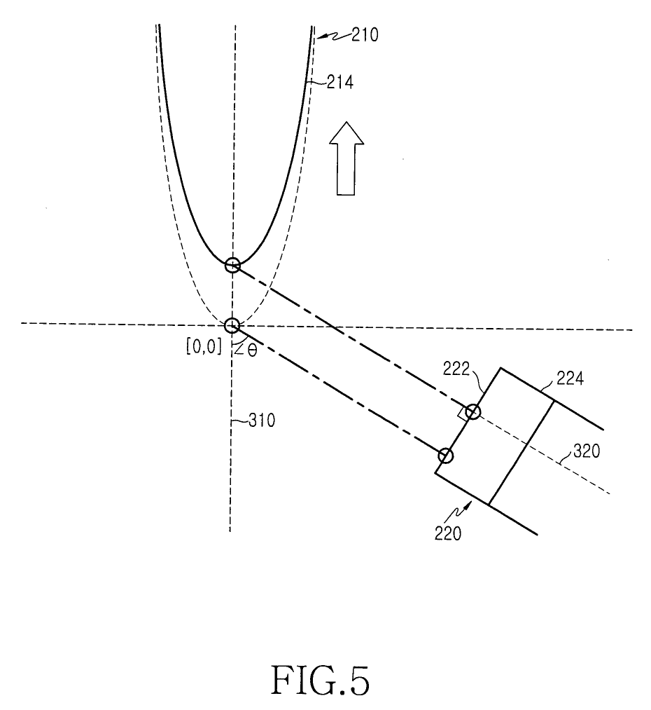

Referring to FIG. 5, the main processor 264 outputs a control signal for compensating for the calculated length difference, and the driving device 266 outputs a driving signal for driving the preform moving unit 240 according to the control signal. Then, the preform moving unit 240 moves the soot preform 210 upward such that the distance between the end point of the soot preform 210 and the front edge 222 of the first torch 220 is maintained at the predetermined value.

As describe above, according to a vapor axial deposition apparatus and a vapor axial deposition method of the present invention, a distance between a soot preform and a first torch is maintained constant, so there is an advantage in that the shape and the refractive index profile of the soot preform can be stably controlled.

Also, since growth size is controlled through image detection and processing procedures in the vapor axial deposition apparatus and the vapor axial deposition method of the present invention, the influences of high temperature and soot particles can be excluded, which enhances precision and reliability of the vapor axial deposition.

The method for implementing the processing shown herein according to the present invention can be stored in a computer-readable form in a recording medium (such as a CD ROM, RAM, floppy disk, hard disk or magneto-optical disk). It would be recognized that the apparatus may include a processor that receives and executes a computer program or a computer-executable code, which may be stored in a memory.

While the invention has been shown and described with reference to certain preferred embodiments thereof, it will be understood by those skilled in the art that various changes in form and details may be made therein without departing from the spirit and scope of the invention as defined by the appended claims and equivalents thereof.

What is claimed is:

1. A vapor axial deposition apparatus comprising:
a first torch for depositing soot on a distal end of a soot preform aligned with a first axis, the first torch being aligned with a second axis;
a growth size detecting unit for detecting an image including a growing point of the soot preform and an end of the first torch; and
a controlling unit for calculating a distance between the soot preform and the first torch along the second axis from the detected image, and moving the soot preform upward based on the calculated distance.

2. The apparatus as claimed in claim 1, wherein the growth size detecting unit comprises:
an illuminating device for illuminating together the growing point of the soot preform and the end of the first torch, the illuminating device being disposed on one side of soot preform; and
an image detecting device for detecting the image including the growing point of the soot preform and the end of the first torch, the image detecting device being disposed on the other side of the soot preform such that the image detecting device is positioned opposite to the illuminating device.

3. The apparatus as claimed in claim 1, further comprising a preform moving unit for fixing an end of the soot preform thereto and moving the soot preform.

4. The apparatus as claimed in claim 3, wherein the controlling unit comprises:
an image processing device for calculating a vertical distance between an end point of the soot preform and a front edge of the first torch from the detected image;
a main processor for comparing the distance calculated in the image processing device with a predetermined reference value, and outputting a control signal so as to compensate for a difference between the calculated distance and the predetermined reference value; and
a driving device for driving the soot preform according to the control signal.

5. The apparatus as claimed in claim 1, wherein the controlling unit moves the soot preform upward such that the vertical distance between the end point of the soot preform and the front edge of the first torch is maintained constant.

6. The apparatus as claimed in claim 1, further comprising a second torch for depositing soot on an outer circumferential surface of the soot preform.

7. A vapor axial deposition method, in which soot is deposited on a distal end of a soot preform aligned with a first axis by using a torch aligned with a second axis, the method comprising the steps of:
(a) detecting an image including a growing point of the soot preform and a front edge of the torch;
(b) calculating a vertical distance between an end point of the soot preform and the front edge of the torch from the detected image; and
(c) moving the soot preform such that the vertical distance between the end point of the soot preform and the front edge of the torch is maintained constant.

8. The method as claimed in claim 7, wherein step (b) comprises the steps of:
(b-1) extending a segment on a side edge of the torch up to a central axis of the soot preform;
(b-2) calculating an included angle formed by the extension line of the segment and the central axis of the soot preform; and
(b-3) calculating the vertical distance between the end point of the soot preform and the front edge of the torch from the included angle.

9. A vapor axial deposition method comprising the steps of:
depositing soot on a distal end of a soot preform aligned with a first axis by a first torch aligned with a second axis;
detecting an image including a growing point of the soot preform and an end of the first torch;
calculating a distance between the soot preform and the first torch along the second axis from the detected image; and
moving the soot preform based on the calculated distance.

10. The method as claimed in claim 9, wherein the step of detecting an images comprises the steps of:
illuminating the growing point of the soot preform and the end of the first torch; and
detecting the image including the growing point of the soot preform and the end of the first torch at a position opposite the position of illuminating.

11. The method as claimed in claim 9, the step of moving comprises the step of:
fixing an end of the soot preform.

12. The method as claimed in claim 9, wherein the step of moving the preform comprises the steps of:
calculating a vertical distance between an end point of the soot preform and a front edge of the first torch from the detected image;
comparing the distance calculated in the image processing device with a predetermined reference value; and
outputting a control signal to compensate for a difference between the calculated distance and the predetermined reference value.

13. The method as claimed in claim 9, wherein the vertical distance between the end point of the soot preform and the front edge of the first torch is maintained constant.

14. The method as claimed in claim 9, further comprising the step of:
depositing soot on an outer circumferential surface of the soot preform by a second torch.
